(19) United States
(12) Patent Application Publication
(10) Pub. No.: US 2024/0423109 A1
(43) Pub. Date: Dec. 26, 2024

(54) HYDROSTATIC AERATOR

(71) Applicant: Doosan Bobcat North America, Inc., West Fargo, ND (US)

(72) Inventor: Mark Wegner, Watertown, WI (US)

(21) Appl. No.: 18/750,372

(22) Filed: Jun. 21, 2024

Related U.S. Application Data
(60) Provisional application No. 63/509,381, filed on Jun. 21, 2023.

(51) Int. Cl. A01B 45/02; A01B 33/08

(52) U.S. Cl. CPC A01B 45/02; A01B 33/082

(57) ABSTRACT

A power system for a power machine with an aerator assembly can include a hydrostatic drive system with a hydraulic drive pump arranged to power a hydraulic drive motor. The power system can further include a hydrostatic aerator system with a hydraulic tine pump arranged to power a hydraulic tine motor.

### CROSS-REFERENCE TO RELATED APPLICATIONS

This application claims priority to and incorporates by reference U.S. Provisional Patent Application No. 63/509,381, filed Jun. 21, 2023.

### BACKGROUND

This disclosure is directed toward power machines. More particularly, this disclosure is directed towards systems for controlling hydraulic functions of a power machine, including hydraulic or hydrostatic drive, as well as hydraulic power implements that may be operably coupled to the power machine. Power machines, for the purposes of this disclosure, include any type of machine that generates power to accomplish a particular task or a variety of tasks.

One type of power machine is a work vehicle. Work vehicles are generally self-propelled vehicles that have a work device, such as a lift arm (although some work vehicles can have other work devices) that can be manipulated to perform a work function. Work vehicles include loaders (including mini-loaders), excavators, utility vehicles, mowers, tractors (including compact tractors), and aerators, to name a few examples.

The discussion above is merely provided for general background information and is not intended to be used as an aid in determining the scope of the claimed subject matter.

### SUMMARY

Embodiments of the invention, as generally disclosed herein, can relate to power systems, and in particular to power machines with an aerator assembly that can include a hydrostatic drive system and a hydrostatic aerator system, each with a separate hydraulic pump that can be configured to power respective motors through a hydrostatic drive circuit and a hydrostatic aerator circuit arranged in a parallel configuration to allow synchronization of speed between the wheels and tines. In some cases, the separate hydraulic pumps can be configured to be stacked together to allow a single operator input to control both pumps. In some embodiments of the invention, the aerator assembly can include separate drive control systems to drive only the motor when disengaging the tines from the ground.

According to some aspects of the disclosure, a power system for a power machine with an aerator assembly is provided. The power system can include a hydrostatic drive system that includes a first hydraulic drive pump arranged to power a first hydraulic drive motor to propel the power machine over terrain. The power system can also include a hydrostatic aerator system that includes a first hydraulic tine pump arranged to power a first hydraulic tine motor to rotate a first tine set of the aerator assembly.

In some examples, the first hydraulic drive pump can be arranged to power the first hydraulic drive motor via a first hydraulic drive circuit. The first hydraulic tine pump can be arranged to power the first hydraulic tine motor via a first hydraulic aerator circuit that is not in operative hydraulic communication with the first hydrostatic drive circuit.

In some examples, the hydrostatic aerator system can include a second hydraulic tine pump that is arranged to power a second hydraulic tine motor to rotate a second tine set of the aerator assembly.

In some examples, the hydrostatic drive system can further include a second hydraulic drive pump that is arranged to power a second hydraulic drive motor to propel the power machine over terrain.

In some examples, the first hydraulic drive pump can be stacked with the first hydraulic tine pump to be collectively driven by a first rotational power input. The second hydraulic drive pump can be stacked with the second hydraulic tine pump to be collectively driven by a second rotational power input.

In some examples, the first tine set can be configured to rotate independently of the second tine set.

In some examples, the power system can include a third tine set that is not powered by the hydrostatic aerator system. The third tine set can be arranged for free-wheeling rotation between the first tine set and the second tine set.

In some examples, the power machine can include a control system. In response to an operator command for a tractive operation, the control system can be configured to adjust a displacement of one or more of the first hydraulic drive pump or the first hydraulic drive motor to adjust a ground-engaging speed of a first tractive element powered by the first hydraulic drive motor. In response to the operator command or the adjustment of the displacement of the one or more of the first hydraulic drive pump or the first hydraulic drive motor, the control system can be configured to adjust a displacement of one or more of the first hydraulic tine pump or the first hydraulic tine motor to adjust a ground-engaging speed of the first tine set.

In some examples, the control system can be configured to automatically adjust the one or more of the first hydraulic tine pump or the first hydraulic tine motor so that the ground-engaging speed of the first tine set is substantially equal to the ground-engaging speed of the first tractive element.

In some examples, a rotational speed of the first hydraulic tine motor can be faster than a rotational speed of the first hydraulic drive motor when the ground-engaging speed of the first tine set is substantially equal to the ground-engaging speed of the first tractive element.

According to some aspects of the disclosure, a power machine is provided. The power machine can include a frame supported by a first tractive element and a second tractive element, and an aerator assembly movable supported on the frame that can include a first tine set and a second tine set arranged to rotate independently of the first tine set. A hydrostatic drive system can include a first hydraulic drive pump that is arranged to power a first hydraulic drive motor, via a first hydrostatic drive circuit, to power a first tractive element. The hydrostatic drive system can also include a second hydraulic drive pump arranged to power a second hydraulic drive motor, via a second hydraulic drive circuit, to power a second tractive element. A hydrostatic aerator system can include a first hydraulic tine pump arranged to power a first hydraulic tine motor, via first hydrostatic aerator circuit, to rotate the first tine set, and a second hydraulic tine pump arranged to power a second hydraulic tine motor via a second hydrostatic aerator circuit to rotate the second tine set. The first and second hydrostatic drive and aerator circuits can be arranged in parallel, so that the first and second hydraulic drive pumps do not power the first and second hydraulic tine motors and the first and second hydraulic tine pumps do not power the first and second hydraulic drive motors.

In some examples, the power machine can include a control system that is configured to adjust a displacement of one or more of the first hydraulic drive pump, the second hydraulic drive pump, the first hydraulic drive motor, or the second hydraulic drive motor to adjust a ground-engaging speed of one or more of the first tractive element or the second tractive element, respectively. Based on the adjustment of the displacement of the one or more of the first hydraulic drive pump, the second hydraulic drive pump, the first hydraulic motor, or the second hydraulic drive motor, the control system can be configured to automatically adjust a displacement of one or more of the first hydraulic tine pump, the second hydraulic tine pump, the first hydraulic tine motor, or the second hydraulic tine motor, to adjust a ground-engaging speed of the corresponding first or second tine set.

In some examples, the control system can be configured to automatically adjust the displacement of the one or more of the first hydraulic tine pump, the second hydraulic tine pump, the first hydraulic tine motor, or the second hydraulic tine motor to be different than an adjusted displacement of the one or more of the first hydraulic drive pump, the second hydraulic drive pump, the first hydraulic drive motor, or the second hydraulic drive motor.

In some examples, the control system can be configured to automatically adjust the displacement of the one or more of the first hydraulic tine pump, the second hydraulic tine pump, the first hydraulic tine motor, or the second hydraulic tine motor to cause the ground-engaging speed at one or more of the first tine set or the second tine set to be substantially equal to the ground-engaging speed at one or more of the first tractive element or the second tractive element.

In some examples, the power machine can include a power source that is supported by the frame. The first hydraulic drive pump and the first hydraulic tine pump can be arranged to be powered by the power source via a first rotational power input interface.

In some examples, the first hydraulic drive pump and the first hydraulic tine pump can be arranged in a stacked configuration.

In some examples, the power machine can include an auxiliary pump that is arranged in a stacked configuration with the first hydraulic drive pump and the first hydraulic tine pump.

According to some aspects of the disclosure, a method of operating a power machine with an aerator assembly is provided. The power machine can be propelled over terrain by, using a power source of the power machine, powering a hydraulic drive pump of a hydrostatic drive system so that the hydraulic drive pump hydraulically powers a hydraulic drive motor of the hydrostatic drive system to rotate a tractive element. While propelling the power machine over the terrain, the aerator assembly can be operated by, using the power source, powering a hydraulic aerator pump of a hydrostatic aerator system so that the hydraulic aerator pump hydraulically powers a hydraulic aerator motor to rotate the aerator assembly.

In some examples, the hydraulic drive pump can hydraulically power the hydraulic drive motor via a hydrostatic drive circuit. The hydraulic aerator pump can hydraulically power the hydraulic aerator motor via a hydrostatic aerator circuit. The hydrostatic aerator circuit can be not in operative hydraulic communication with the hydrostatic drive circuit.

In some examples, in response to an operator command for a tractive operation, a displacement of one or more of the hydraulic aerator pump or the hydraulic aerator motor can be automatically adjusted. A ground-engaging speed of the aerator assembly can be adjusted to be substantially equal to a ground-engaging speed of the tractive element.

This Summary and the Abstract are provided to introduce a selection of concepts in a simplified form that can be further described below in the Detailed Description. This Summary and the Abstract are not intended to identify key features or essential features of the claimed subject matter, nor to be used as an aid in determining the scope of the claimed subject matter.

### DRAWINGS

The following drawings are provided to help illustrate various features of non-limiting examples of the disclosure and are not intended to limit the scope of the disclosure or exclude alternative implementations.

FIG. 1 is a block diagram illustrating functional systems of a representative power machine on which examples of the present disclosure can be advantageously practiced.

FIG. 2 schematically illustrates an example power system for a power machine according to examples of the disclosed technology.

FIG. 3 schematically illustrates an example configuration of the power system of FIG. 2, for a power machine configured as an aerator.

FIG. 4 illustrates an exploded view of an example tine assembly for the aerator of FIG. 3.

### DETAILED DESCRIPTION

The concepts disclosed in this discussion are described and illustrated by referring to exemplary configurations. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

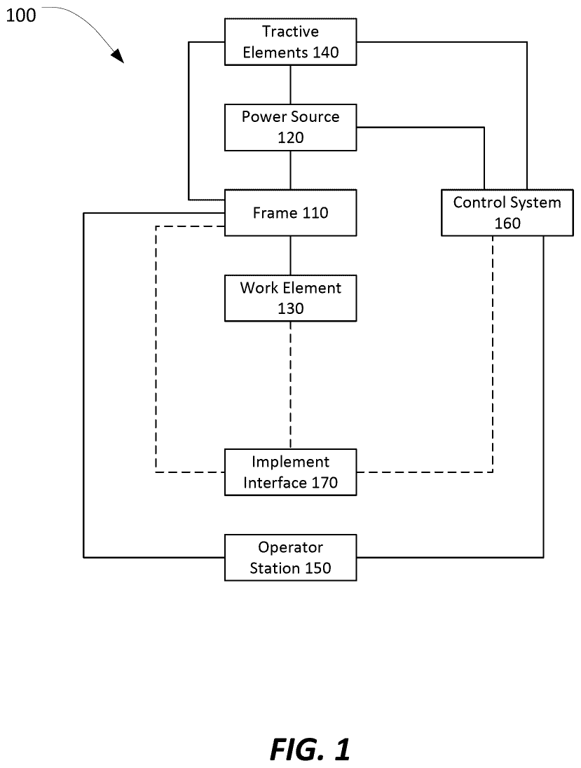

FIG. 1 is a block diagram that illustrates the basic systems of a power machine 100 that can advantageously incorporate the disclosed technology, including the specific examples in the FIGS. and further discussed below. The block diagram of FIG. 1 both identifies various systems on power machine 100 and shows relationships between various components and systems, which can be variously implemented using a combination of known technologies and the technology disclosed herein.

In particular, the power machine 100 has a frame 110, a power source 120, and a work element 130. Because the power machine 100 as shown is a self-propelled work vehicle, it also has tractive elements 140, i.e., wheels, track assemblies, or other work elements configured to move the power machine over a support surface. Some examples can include an operator station 150 that provides an operating position from which an operator can manipulate operator inputs for controlling the work elements of the power machine.

A control system 160 is provided to interact with the other systems to perform various work tasks, including automatically or in response to control signals provided by an operator (e.g., from the operator station 150). For example, the control system 160 can be an integrated or distributed architecture of one or more processor devices and one or more memories that are collectively configured to receive operator input or other input signals (e.g., sensor data) and to output commands accordingly for operation of the power machine 100. Such commands, for example, may include tractive commands to control movement of the tractive elements 140 (e.g., for straight- or turning-travel tractive operations) or work commands to control other work elements (e.g., to move a lift arm or operate an attached implement). According to some examples, the control system 160 can include a hydraulic circuit provided to interact with other systems to perform various work tasks at least in part in response to signals given by an operator by way of movement of input devices arranged on the power machine 100 (e.g., within the operator station 150). In this regard, for example, the control system 160 can include one or more control valves, associated operator controls, or other known types of hydraulic control equipment. In some examples, the control system 160 can include both electronic and hydraulic components.

Certain work vehicles have work elements 130 that can perform a particular task. For example, some work vehicles have a lift arm to which one or more implements can be attached (e.g., a bucket, a mower deck, an aerator, or other ground-conditioning equipment, attached by a pinning arrangement or otherwise). The work elements 130 are typically supported by the frame 110 of the power machine 100 and movable with respect to the frame 110 when performing a work task. In some examples, work elements can include lift arm assemblies. In some examples, work elements can include aerators, mower decks, or other similar equipment. As mentioned above, the tractive elements 140 are also, generally, work elements, and can specifically include track assemblies, wheels attached to an axle, and the like. In some examples, the tractive elements 140 can be mounted to the frame 110 such that movement of the tractive element 140 is limited to rotation about an axle. Accordingly, in some cases, steering can be accomplished by a skidding action or by controlled rotation of opposing wheels in opposing directions (e.g., for zero-radius turning, as further facilitated in some cases by caster wheels or other ground-engaging elements). In some examples, the tractive elements 140 can be pivotally mounted to the frame to accomplish steering by pivoting the tractive element with respect to the frame.

Correspondingly, the control system 160 can be configured to operate a work element to perform a particular task. For example, in response to sensor input or operator input, the control system 160 can manipulate a lift arm, control a motor or pump, start or stop powered operation of a particular implement, control travel via control of the tractive elements 140, etc.

In some examples, the power machine 100 can include an implement interface 170 (e.g., attached to a lift arm or other work element 130, as shown in FIG. 1). The implement interface 170 is a connection mechanism between the frame 110 or a work element 130 and an implement, and can include simple connections (e.g., integral or attached structures for a pinned connection) or more complex connections (e.g., for controllably movable attachment of an implement to a lift arm or other work element).

On some power machines, the implement interface 170 can include an implement carrier, i.e., a physical structure movably attached to a work element (e.g., a lift arm) to support an implement relative to the work element. The implement carrier can have engagement features and locking features to accept and secure any of a number of different implements to the work element. In some examples, the implement interface 170 can also include one or more power connectors for providing power to one or more work elements on an implement (e.g., for hydraulic or electric transmission of power from the power source 120). Similarly, the implement interface 170 can include one or more signal connectors for providing control signals (e.g., command or sensor signals) to or from an attached implement.

Frame 110 includes a physical structure that can support various other components that are attached thereto or positioned thereon. The frame 110 can include any number of individual components. Some power machines have frames that are rigid. That is, no part of the frame 110 is movable with respect to another part of the frame. In other example, the frame 110 can include at least one portion that can move with respect to another portion of the frame. For example, some tractors and other work vehicles can include articulated frames such that one portion of the frame (e.g., a front portion) pivots with respect to another portion (e.g., a rear portion).

Frame 110 supports the power source 120, which is configured to provide power to one or more work elements 130 including, in various cases, the tractive elements 140 and implements attached to the implement interface 170 (e.g., via one or more hydraulic connections on or near the implement interface 170). Power from the power source 120 can be provided directly to any of the work elements 130, the tractive elements 140, or the implement interfaces 170 (e.g., as controlled by the control system 160). Alternatively, power from the power source 120 can be provided to a control system 160, which in turn selectively provides power to the elements that capable of using it to perform a work function. For example, hydraulic power produced using rotational power from the power source 120 can be routed through a hydraulic control valve of the control system 160 for operation of one or more hydraulic motors.

Power sources for a power machine can include an engine (e.g., an internal combustion engine) or various electrical power sources (e.g., a battery assembly, a capacitor, a hydrogen fuel cell, an ethanol fuel cell, a methanol fuel cell, etc.). In some examples, a power machine can further include a power conversion system (not shown in FIG. 1). A power conversion system can generally be configured to convert power from a power source to usable form for a particular power machine or work element (e.g., to use rotational power from an engine to provide hydraulic pressure/flow, or to controllably provide a particular electrical current). Power conversion systems can also transmit power to other locations on a power machine (e.g., via geared or other mechanical transmission systems, or via hydraulic circuits that guide hydraulic flow to a hydraulic motor or other hydraulically powered device).

Power machine 100 includes an operator station 150 that includes an operating position from which an operator can control operation of the power machine. In some power machines, the operator station 150 is defined by an enclosed or partially enclosed cab. However, some power machines on which the disclosed technology may be practiced may not have a cab or an operator compartment of the type described above. For example, a walk behind aerator or other similarly configured power machine may not have a cab or an operator compartment. In some examples, a walk behind aerator or other similarly configured power machine may not include an onboard operator compartment or platform, but may include various human-machine interfaces (e.g., levers, joysticks, etc.) that can be engaged by an operator from outside of (e.g., behind) the power machine.

Some power machines, whether or not they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that is capable of controlling at least some of the operator-controlled functions on the power machine.

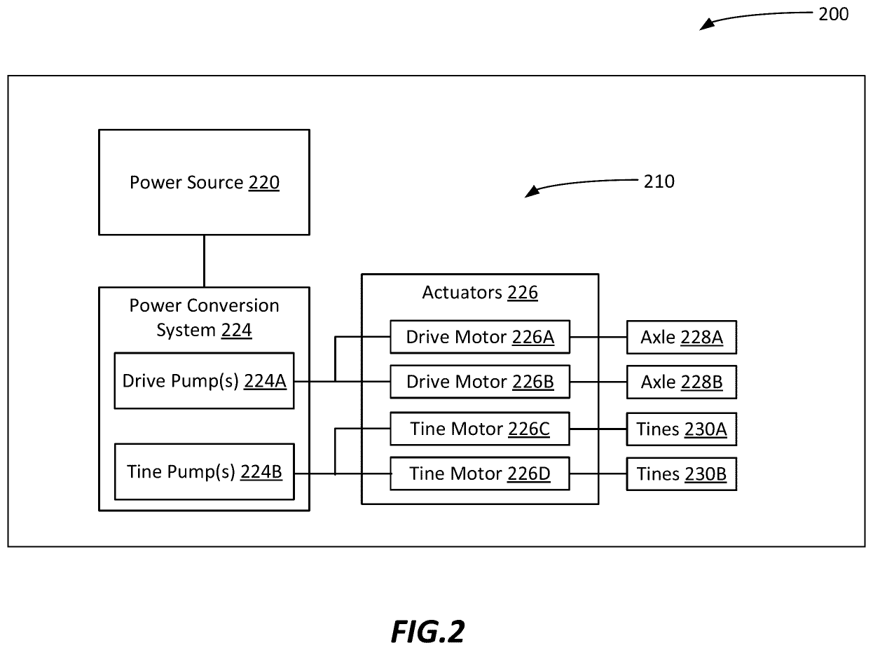

FIG. 2 schematically illustrates an example configuration of a power machine 200, with a power system 210 (e.g., corresponding to a particular configuration of the power machine 100). In particular, the power system 210 includes a power source 220 that can produce or store power for the power machine 200. The power source 220 can be an internal combustion engine in some examples, or can variously be an electric generator, a rechargeable or replaceable battery, etc. The power system 210 also includes a power conversion system 224, which is operably coupled to the power source 220. For example, the power conversion system 224 in particular examples discussed below can be mechanically coupled to the power source 220 to receive rotational power from the power source 220 (or various intermediary equipment). Power conversion system 224 is, in turn, operatively coupled to one or more actuators 226, so that the power conversion system 224 can provide power for operation of the actuators 226 for corresponding functions on the power machine 200. In some examples, in particular, a power source can provide rotational power at an output interface (e.g., output shaft) and a mechanical transmission can transmit the rotational power directly to multiple pumps (e.g., to one or more drive pumps and one or more tine pumps collectively arranged along a drive shaft operably coupled to the output interface).

In the illustrated example, the power conversion system 224 includes one or more hydrostatic drive pumps 224A that are selectively controllable to provide hydraulic power to hydrostatic drive motors 226A, 226B (e.g., via control of a variable displacement of the pump(s) 224A). In particular, as further discussed below, a particular drive pump 224A can power operation of the drive motor 226A, and a different drive pump 224A can power operation of the drive motor 226B (e.g., in a skid steer configuration). In other examples, however, other configurations are possible. A charge pump (not shown) can also be included in some cases to provide a flow/pressure source for the activation of the controls for the hydrostatic drive pump(s) 224A. Further, the drive motor(s) 226A or 226B can also (or alternatively) be configured with variable displacement in some examples.

The drive pump(s) 224A can be mechanically, hydraulic, or electrically coupled to operator input devices—or to the control system 160 generally (see FIG. 1)—to receive actuation signals for controlling drive operations (e.g., via selective adjustment of pump or motor displacement in response to corresponding operator commands). In the illustrated examples, the drive motors 226A, 226B are each operably coupled to respective axles 228A, 228B, which in turn can be coupled to corresponding wheels or other ground-engaging tractive elements. Thus, the power system 210 can be used for a two-wheel drive configuration of the power machine 200, in which the motor 226A (or a particular pump 224A) is controlled to provide left-side tractive power and the motor 226B (or a different pump 224A) is controlled to provide right-side tractive power. According to other examples, a power machine can include more or fewer drive motors, powered axles, or other related components (e.g., in a four-wheel drive or other generally known configurations).

Still referring to FIG. 2, the power conversion system 224 can also include one or more additional hydraulic pumps 224B (e.g., variable displacement pumps) configured to provide hydraulic power to one or more non-tractive motors (e.g., variable displacement motors). In particular, the one or more pumps 224B can be configured as tine pump(s) 224B (as shown) that are selectively controllable to power corresponding hydrostatic tine motors 226C, 226D. The tine motors 226C, 226D, in turn, can thus power rotation of sets of tines 230A, 230B of a tine assembly (e.g., separately rotatable tine sub-assemblies 230A, 230B, each with a customizable pattern of protruding tines) or rotation of other known types of aerator assemblies configured to aerate terrain. Conventional aerators can include multiple chains, sprockets, and bearings to transfer rotational movement for drive and aerator functions. This arrangement can require a user to frequently provide maintenance to the chains and sprockets after each subsequent use of the aerator, which can require excess costs and time. In contrast, the drive and tine pumps 224A, 224B can allow for hydraulic operation—and in particular independent hydraulic operation—of the axles 228A, 228B for tractive operations and of the tines 230A, 230B for aeration. The power machine 200 can thus generally avoid the problems noted above.

In some examples, a power system can include a single pump to drive a drive motor and a tine assembly. For example, some configurations can include drive wheels (or other tractive elements) and tine assemblies that are powered in series with each other. This may helpfully match movement of the wheels and drive tine assemblies, so that when the left (or right) drive wheel is powered to rotate in a particular direction, the left (or right) tine assembly is also powered to rotate in the same direction. However, during some operations, this arrangement may not allow for refined, separate control of the drive wheels and the drive tine assemblies.

To address these and other issues, some examples of the disclosed technology can include drive and tine assemblies that are configured to be powered in parallel with each other, rather than in series. For example, to power an aerator assembly of the power machine 200, the tine pumps 224B can include a first tine pump to power the tine motor 226C, and a second tine pump to power the tine motor 226D. Similarly, the drive pumps 224A can include a first drive pump to power the drive motor 226A and a second drive pump to power the second drive motor 226B. Correspondingly, the drive pumps 224A can power the drive motors 226A, 226B using respective hydrostatic drive circuits that are hydraulically in parallel with hydrostatic aerator circuits that allow the tine pumps 224B, respectively, to power the tine motors 226C, 226D.

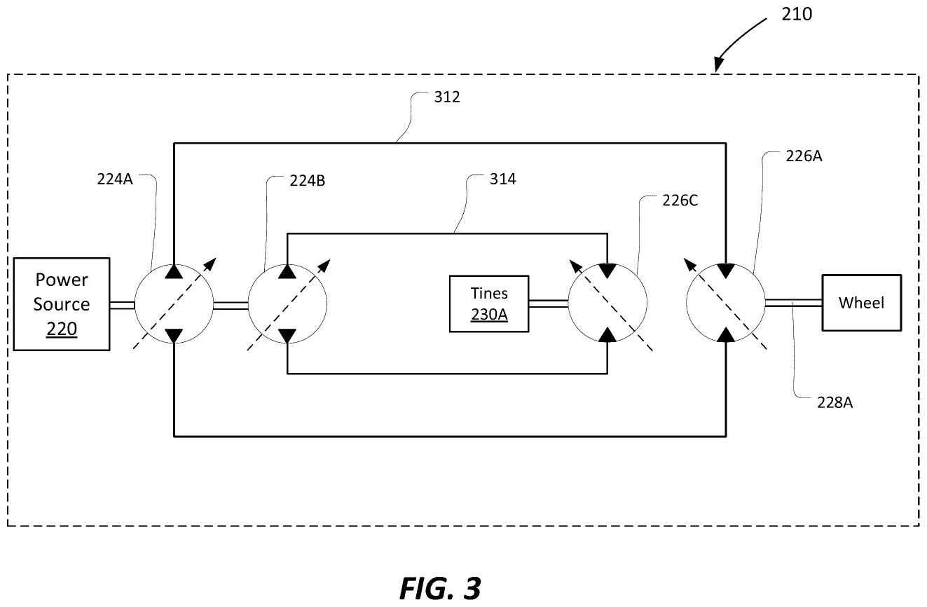

In this regard, FIG. 3 schematically illustrates an example configuration 300 of a portion of the power system 210 that is configured to power a right (or other) side of the power machine 200, with parallel flow loops to power the tines 230A and the axle 228A. As illustrated, a wheel is used as a ground-engaging element that is powered by the motor 226A via the axle 228A. In some examples, the motor 226A can power other ground-engaging elements, such as an endless track assembly. As shown schematically with dashed arrows in FIG. 3, one or more of the motors/pumps 224A, 224B, 226A, or 226C can be configured for variable displacement in some examples. In some examples, only the pumps 224A, 224B or only the motors 226A, 226C may be configured for variable displacement.

In particular, as shown in FIG. 3, a hydrostatic drive circuit 312 can be arranged in parallel with a hydrostatic tine (or, generally, aerator) circuit 314. In such a configuration, for example, the hydrostatic drive circuit 312 may not be in operative hydraulic communication with hydrostatic tine circuit 314 (i.e., neither circuit 312, 314 may receive or provide hydraulic power to the other for the operation of the motors 226A, 226C). Thus, for example, the power source 220 can provide rotational power to the drive pump 224A and to the tine pump 224B (e.g., via a belt system), and the pumps 224A, 224B can operate in parallel to provide hydraulic flow in the respective circuit 312, 314. These parallel flows can then power, in parallel, rotation of the drive motor 226A and the tine motor 226C, respectively. A similar other arrangement (not shown) can also be provided for a left (or other) side of the power machine 200, using similar parallel hydraulic arrangements for another of the drive pumps 224A, another of the tine pumps 224B, and the drive and tine motors 226B, 226D. Generally, this configuration can allow the pumps 224A, 224B to separately power tines and wheels during operation, thus allowing for more adaptable and independent control over drive and aerating functions.

In these and other arrangements according to the disclosed technology, it may be useful to ensure coordinated operation of drive and tine pumps (or motors). In particular, some arrangements can be controlled to ensure that particular tractive elements rotate concurrently with the corresponding tine assemblies, with respective speeds configured so that the tine assemblies operate to aerate but not damage terrain as the power machine travels. In particular, some arrangements can ensure that the ground-engaging speed of a rotating tine assembly is appropriately matched (e.g., substantially equal) to the ground-engaging speed of a corresponding tractive element (i.e., with ground-engaging speed measured as the circumferential speed at the rolling radius of the relevant ground-engaging tractive element or tine assembly). Thus, for example, some arrangements can simultaneously operate drive and tine pumps with different run-time displacements, to provide for substantially equal speeds at differing drive and tine rolling radii.

In this regard, a single operator input can be provided in some cases (e.g., via the control system 160) to simultaneously control rotation of ground-engaging elements and tines on a particular side of a power machine. For example, based on an operator command corresponding to a particular travel speed for the power machine 200, one or more of the right-side drive pump 224A or the right side drive motor 226A can be commanded to a corresponding displacement. Responsive to the operator command or the corresponding drive displacement adjustment, a corresponding command can be automatically provided to the right-side tine motor 226B, to match the ground-engaging speed of the right-side ground-engaging elements with the ground-engaging speed of the right-side tines 230A. Similar operations can also (or alternatively) be implemented for left-side components, as needed.

In some examples, such a simultaneous command can be provided by mechanically (or otherwise) tying a control arm of the relevant drive pump 224A to a control arm of the corresponding tine pump 224B. With the system thus arranged, stroking the drive pump 224A can then result in a corresponding (e.g., simultaneous) stroking of the tine pump 224B, so that an appropriate relationship between displacement of the pumps 224A, 224B can be maintained. In other examples, however, other control arrangements can be used, including systems for synchronized electronic or hydraulic adjustment of pump displacement. Thus, for example, displacement of relevant pumps or motors can be appropriately controlled with synchronized adjustment, to cause synchronized speed changes at corresponding tractive and aeration elements.

In some examples, the pumps 224A (or the motors 226A, 226B) can be differently sized than the pumps 224B (or the motors 226C, 226D), with corresponding differences in displacement control to ensure that the relevant ground-engaging elements of tractive and tine assemblies are appropriately synchronized. For example, a maximum or minimum displacement, or a corresponding displacement range of one or more of the pumps/motors 224A, 226A, or 226B can be greater, respectively, than a maximum or minimum displacement, or a corresponding displacement range of one or more of the pumps/motors 224B, 226C, 226D. As generally noted above, pump (or motor) displacement can be controlled so that the relevant tine assemblies operate at higher (i.e., faster) rotational speeds than corresponding tractive elements, because the tine assemblies may generally be of smaller diameter than the tractive elements. However, other configurations are possible, depending on the geometry of a particular machine.

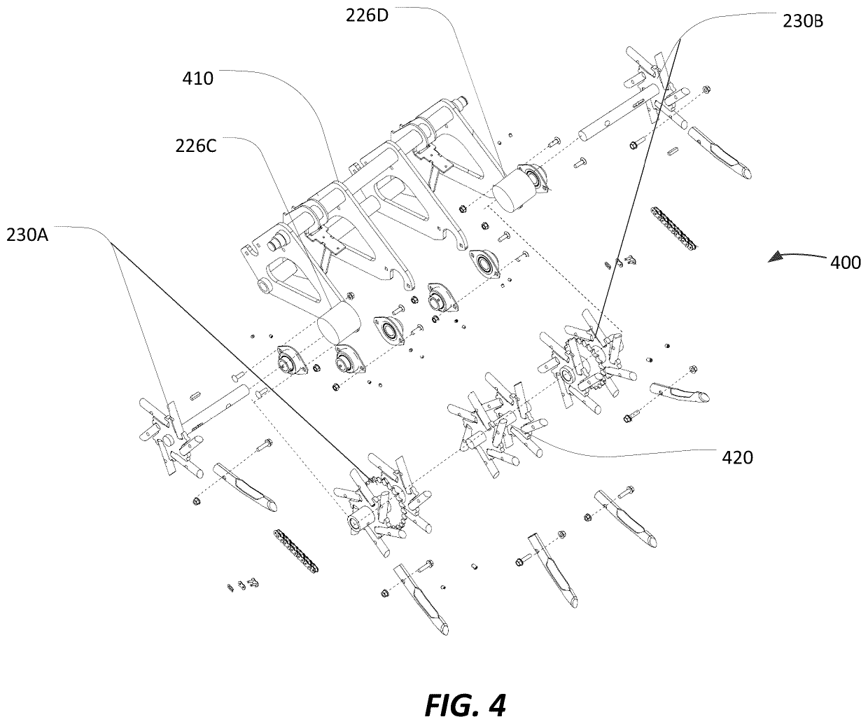

FIG. 4 schematically illustrates an exploded view of an example aerator assembly 400 for a power machine, including as can be implemented for the power machine 200 of FIGS. 2 and 3. In particular, the tine motor 226C can be supported on a frame 410 (e.g., pivotable relative to the frame 110) to power rotation of the tines 230A, and the tine motor 226D can be supported on the frame 410 to power rotation of the tines 230B. In different cases, the tine motors 226C, 226D can be nested within the frame 410 or can be mounted proud thereof. In some cases, the tine motors 226C, 226D can be assembled into the tines 230A, 230B, but can otherwise similarly power rotation of the tines 230A, 230B relative to the frame 410. In various configurations, the tines 230A, 23B can be supported on a drum, a spindle, or other body that be rotatably secured to the frame 410.

Generally, the tines 230A, 230B can rotate independently of each other, including for rotation in opposite directions. Thus, for example, the tines 230A, 230B can rotate in a common direction with the respective associated axle 228A, 228B (see FIG. 2) to prevent damage to terrain, including during skid-steer turns or other maneuvers. In some cases, non-powered tines can also be included. As shown in FIG. 4, the aerator assembly 400 can also include a third tine set 420, arranged between the first and second tines 230A, 230B, and not configured for powered rotation. In other words, the tines 420 can be arranged to be free-wheeling to allow for smoother turns and other operations.

In some examples, a hydraulic drive pump can be arranged in a stacked configuration with a corresponding hydraulic tine pump, to be collectively driven by a first rotational power input interface (e.g., by a single input shaft or socket, as illustrated schematically in FIG. 3). Thus, for example, the tine pump may always rotate with the drive pump and may correspondingly always be available to power rotation of the relevant tine assembly when the drive pump is operating. In some examples, however, it may be possible to conduct drive operations without rotating a tine assembly. For example, a tine pump can be powered separately from a corresponding drive pump in some cases (e.g., to allow the tines 230A, 230B to not rotate under power during travel of the power machine 200 with the frame 410 is pivoted out of engagement with the ground). Further, in some cases, one or more additional pumps can be similarly provided, which can also be stacked with a drive and tine pump or can be otherwise supported. For example, an auxiliary pump to raise or lower tines or perform other auxiliary functions can be stacked with a drive pump and a tine pump, or can be otherwise added to a relevant hydraulic system for powered operation.

Thus, embodiments of the invention provide improved power system for aerators, with a hydrostatic drive circuit and a hydrostatic aerator circuit to separately power drive and aerator operations. In particular, drive and aerator circuits can be configured in parallel arrangements, so that a drive pump and motor powers tractive operations and a separate tine pump and motor powers rotation of a tine assembly. Thus, users can conduct aerator operations with greater flexibility and control, including as may provide for reduce damage to terrain and improved overall efficiency.

Although the presently disclosed technology has been described by referring preferred examples, workers skilled in the art will recognize that changes may be made in form and detail without departing from the scope of the discussion.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Where specified in particular, “substantially” can indicate a variation in one numerical direction relative to a reference value. For example, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

What is claimed is:

1. A power machine comprising:
a frame supported by a first tractive element and a second tractive element;
an aerator assembly movable supported on the frame, including a first tine set and a second tine set arranged to rotate independently of the first tine set;
a hydrostatic drive system that includes:
a first hydraulic drive pump arranged to power a first hydraulic drive motor, via a first hydrostatic drive circuit, to power the first tractive element; and
a second hydraulic drive pump arranged to power a second hydraulic drive motor, via a second hydrostatic drive circuit, to power the second tractive element; and
a hydrostatic aerator system that includes:
a first hydraulic tine pump arranged to power a first hydraulic tine motor, via a first hydrostatic aerator circuit, to rotate the first tine set; and
a second hydraulic tine pump arranged to power a second hydraulic tine motor, via a second hydrostatic aerator circuit, to rotate the second tine set;
wherein the first hydrostatic drive circuit is arranged in parallel with the first hydrostatic aerator circuit and the second hydrostatic drive circuit is arranged in parallel with the second hydrostatic aerator circuit, so that the first and second hydraulic drive pumps do not power the first and second hydraulic tine motors and the first and second hydraulic tine pumps do not power the first and second hydraulic drive motors.

2. The power machine of claim 1, further comprising a control system configured to:
adjust a displacement of one or more of the first hydraulic drive pump, the second hydraulic drive pump, the first hydraulic drive motor, or the second hydraulic drive motor to adjust a ground-engaging speed of one or more of the first tractive element or the second tractive element, respectively; and
based on the adjustment of the displacement of the one or more of the first hydraulic drive pump, the second hydraulic drive pump, the first hydraulic drive motor, or the second hydraulic drive motor, automatically adjust a displacement of one or more of the first hydraulic tine pump, the second hydraulic tine pump, the first hydraulic tine motor, or the second hydraulic tine motor, to adjust a ground-engaging speed of the corresponding first or second tine set.

3. The power machine of claim 2, wherein the control system is configured to automatically adjust the displacement of the one or more of the first hydraulic tine pump, the second hydraulic tine pump, the first hydraulic tine motor, or the second hydraulic tine motor to be different than an adjusted displacement of the one or more of the first hydraulic drive pump, the second hydraulic drive pump, the first hydraulic drive motor, or the second hydraulic drive motor.

4. The power machine of claim 3, the control system is configured to automatically adjust the displacement of the one or more of the first hydraulic tine pump, the second hydraulic tine pump, the first hydraulic tine motor, or the second hydraulic tine motor to cause the ground-engaging speed at one or more of the first tine set or the second tine set to be substantially equal to the ground-engaging speed at one or more of the first tractive element or the second tractive element.

5. The power machine of claim 1, further comprising:
a power source supported by the frame;
wherein the first hydraulic drive pump and the first hydraulic tine pump are arranged to be powered by the power source via a first rotational power input interface.

6. The power machine of claim 5, wherein the first hydraulic drive pump and the first hydraulic tine pump are arranged in a stacked configuration.

7. The power machine of claim 6, further comprising an auxiliary pump arranged in a stacked configuration with the first hydraulic drive pump and the first hydraulic tine pump.

8. A power system for aerator operations with a power machine, the power system comprising:
a hydrostatic drive system, including a first hydraulic drive pump arranged to power a first hydraulic drive motor to propel the power machine over terrain; and
a hydrostatic aerator system, including a first hydraulic tine pump arranged to power a first hydraulic tine motor to rotate a first tine set of an aerator assembly.

9. The power system of claim 8, wherein the first hydraulic drive pump is arranged to power the first hydraulic drive motor via a first hydrostatic drive circuit; and
wherein the first hydraulic tine pump is arranged to power the first hydraulic tine motor via a first hydrostatic aerator circuit that is not in operative hydraulic communication with the first hydrostatic drive circuit.

10. The power system of claim 9, wherein the hydrostatic aerator system further includes a second hydraulic tine pump arranged to power a second hydraulic tine motor, to rotate a second tine set of the aerator assembly.

11. The power system of claim 10, wherein the hydrostatic drive system further includes a second hydraulic drive pump arranged to power a second hydraulic drive motor, to propel the power machine over terrain.

12. The power system of claim 11, wherein the first hydraulic drive pump is stacked with the first hydraulic tine pump to be collectively driven by a first rotational power input; and
wherein the second hydraulic drive pump is stacked with the second hydraulic tine pump to be collectively driven by a second rotational power input.

13. The power system of claim 10, wherein the first tine set is configured to rotate independently of the second tine set.

14. The power system of claim 10, further comprising:
a third tine set, not powered by the hydrostatic aerator system;
the third tine set being arranged for free-wheeling rotation between the first tine set and the second tine set.

15. The power system of claim 8, further comprising:
a control system configured to:
in response to an operator command for a tractive operation, adjust a displacement of one or more of the first hydraulic drive pump or the first hydraulic drive motor to adjust a ground-engaging speed of a first tractive element powered by the first hydraulic drive motor; and
in response to the operator command or the adjustment of the displacement of the one or more of the first hydraulic drive pump or the first hydraulic drive motor, automatically adjust a displacement of one or more of the first hydraulic tine pump or the first hydraulic tine motor to adjust a ground-engaging speed of the first tine set.

16. The power system of claim 15, wherein the control system is configured to automatically adjust the one or more of the first hydraulic tine pump or the first hydraulic tine motor so that the ground-engaging speed of the first tine set is substantially equal to the ground-engaging speed of the first tractive element.

17. The power system of claim 16, wherein a rotational speed of the first hydraulic tine motor is faster than a rotational speed of the first hydraulic drive motor when the ground-engaging speed of the first tine set is substantially equal to the ground-engaging speed of the first tractive element.

18. A method of operating a power machine that includes an aerator assembly, the method comprising:
propelling the power machine over terrain by powering a hydraulic drive pump of a hydrostatic drive system, using a power source of the power machine, so that the hydraulic drive pump hydraulically powers a hydraulic drive motor of the hydrostatic drive system to rotate a tractive element; and
while propelling the power machine over the terrain, operating the aerator assembly by powering a hydraulic aerator pump of a hydrostatic aerator system, using the power source, so that the hydraulic aerator pump hydraulically powers a hydraulic aerator motor to rotate the aerator assembly.

19. The method of claim 18, wherein the hydraulic drive pump hydraulically powers the hydraulic drive motor via a hydrostatic drive circuit;
wherein the hydraulic aerator pump hydraulically powers the hydraulic aerator motor via a hydrostatic aerator circuit; and
wherein the hydrostatic aerator circuit is not in operative hydraulic communication with the hydrostatic drive circuit.

20. The method of claim 18, further comprising:
in response to an operator command for a tractive operation, automatically adjusting a displacement of one or more of the hydraulic aerator pump or the hydraulic aerator motor, to adjust a ground-engaging speed of the aerator assembly to be substantially equal to a ground-engaging speed of the tractive element.
